(19) United States
(12) Patent Application Publication
(10) Pub. No.: US 2020/0251008 A1
(43) Pub. Date: Aug. 6, 2020

(54) SIMILARITY-BASED QUESTION RECOMMENDATION METHOD AND SERVER

(71) Applicant: MEDIOPIA TECH CORPORATION, Seoul (KR)

(72) Inventors: Kyung Sun Park, Seoul (KR); Si Young Kwag, Seoul (KR)

(21) Appl. No.: 16/439,593

(22) Filed: Jun. 12, 2019

(30) Foreign Application Priority Data
Feb. 1, 2019 (KR) 10-2019-0013230

(51) Int. Cl. G09B 7/04

(52) U.S. Cl. CPC G09B 7/04

(57) ABSTRACT

Provided are a similarity-based question recommendation method and server, and more particularly, to a similarity-based question recommendation method and server which recommend questions between highly similar students by analyzing the similarity between students. A similarity-based question recommendation method performed by a computing device, the method including: forming a point indicating a first student and a point indicating a second student in a first Euclidean space, comparing a student reference distance with a student absolute distance and recommending content related to the second student to a terminal of the first student if the student absolute distance is equal to or less than the student reference distance, wherein the first Euclidean space is comprised of a plurality of axes corresponding to one or more questions, respectively.

### CROSS-REFERENCE TO PRIORITY APPLICATIONS

This application claims the benefit of Korean Patent Application No. 10-2019-0013230, filed on Feb. 1, 2019, in the Korean Intellectual Property Office, the disclosure of which is incorporated herein by reference in its entirety.

### BACKGROUND

### Field

The present disclosure relates to a similarity-based question recommendation method and server, and more particularly, to a similarity-based question recommendation method and server which recommend questions between highly similar students by analyzing the similarity between students.

### Description of the Related Art

A learning management system (LMS) is a system that manages students' grades, progress, attendance, etc. online. The majority of conventional LMSs manage students' grades by simply providing questions to students or collecting answers to provided questions. However, the conventional LMSs fail to provide each student with questions of appropriate difficulty and fail to efficiently provide questions for enhancing the learning effect.

To solve this problem, Korean Patent Publication No. 10-2017-0034106, entitled “Apparatus and Method of Recommending Questions of Appropriate Difficulty to User,” discloses a technology that determines the levels of difficulty of questions that users solved and provides questions of an appropriate difficulty level to a user who is to solve questions by estimating the level of the user. However, since this technology fails to accurately estimate the level of each user, if the level of a user is estimated incorrectly, too difficult questions or too easy questions may be provided to the user. Consequently, the user's learning cannot be efficiently enhanced. In addition, in a situation where student data becomes abundant, this technology recommends questions based on simple question classification without efficiently utilizing the abundant data.

Therefore, there is a need for a technology that efficiently recommends questions between students by developing an intelligent collaborative filtering algorithm for finding a student of a similar level based on relative information of students and then recommending questions from the similar student.

### SUMMARY

Aspects of the present disclosure aim to find a student whose learning ability is most similar to that of a specific student by using students' scores on questions and provide questions most appropriate for gradually enhancing the specific student's learning ability by using questions provided to the student whose learning ability is most similar to that of the specific student.

According to an aspect of the present disclosure, there is provided AI (Artificial Intelligence) that can more efficiently recommend questions to students by applying a collaborative filtering technique, which is one of the algorithm recommendation techniques.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

These and/or other aspects will become apparent and more readily appreciated from the following description of the embodiments, taken in conjunction with the accompanying drawings.

FIG. 1 shows an overview of a similarity-based question recommendation system according to an embodiment.

FIG. 2 is a flowchart illustrating a similarity-based question recommendation method according to an embodiment.

FIG. 3 is a score data table stored in a similarity-based question recommendation server according to an embodiment.

FIG. 4 is a table obtained by rearranging the score data of FIG. 3.

FIG. 5 illustrates a first Euclidean space formed using the table.

FIG. 6 illustrates absolute distances between students' points formed in FIG. 5.

FIG. 7 illustrates student reference distances from a point of a first student.

FIG. 8 illustrates the students' points of FIG. 5 moved after the update of the score data.

FIG. 9 illustrates the student reference distances of FIG. 7 changed after the update of learning related data.

FIG. 10 illustrates each level group of students concentrated within a predetermined range.

FIG. 11 is a flowchart illustrating a similarity-based question recommendation method according to an embodiment.

FIG. 12 is a flowchart illustrating operation S250 of FIG. 11 in detail.

FIG. 13 is a table obtained by rearranging the score table of FIG. 3.

FIG. 14 illustrates a second Euclidean space formed using the table; and

15 illustrates the hardware configuration of a question recommendation server according to an embodiment.

### DETAILED DESCRIPTION

Hereinafter, preferred embodiments of the present invention will be described with reference to the attached drawings. Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms including technical and scientific terms used herein have the same meaning as commonly understood by one of ordinary skill in the art to which this invention belongs. Further, it will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The terms used herein are for the purpose of describing particular embodiments only and is not intended to be limiting. As used herein, the singular forms are intended to include the plural forms as well, unless the context clearly indicates otherwise.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, embodiments of the present disclosure will be described with reference to the drawings.

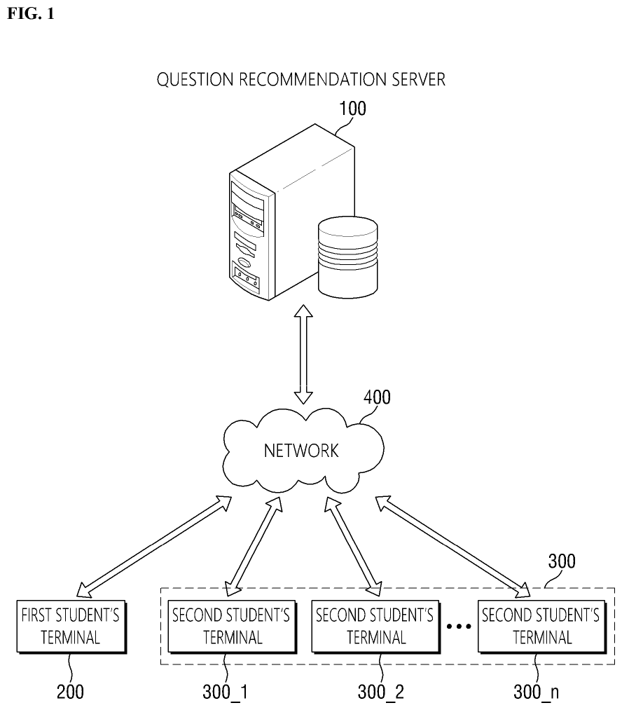

FIG. 1 shows an overview of a similarity-based question recommendation system according to an embodiment.

Referring to FIG. 1, the similarity-based question recommendation system according to the embodiment may include a question recommendation server 100, a terminal 200 of a first student, and a terminal 300 of a second student.

The question recommendation server 100 is a server that performs a method executed by a computing device and may perform a similarity-based question recommendation method S100 according to an embodiment. The question recommendation server 100 may be a device that stores questions in a database and provides questions to students' terminals. The question recommendation server 100 may store and analyze information collected from students' terminals. By performing similarity-based question recommendation method S100 according to the embodiment, the question recommendation server 100 may determine the similarity between students, recommend questions between terminals of similar students based on the determined similarity, and provide the recommended questions to the terminals of the similar students.

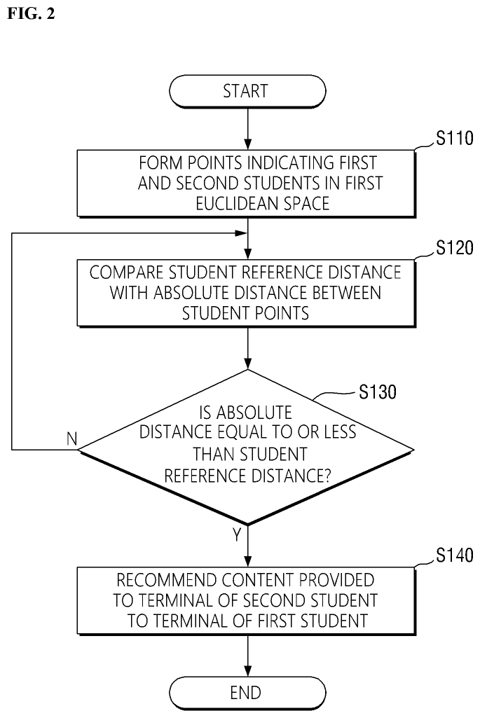

The terminals 200 and 300 of the students may be connected to the question recommendation server 100 through a network 400 so as to receive questions from the question recommendation server 100. The terminals 200 and 300 of the students may include the terminal 200 of the first student and the terminal 300 of the second student. The terminal 200 of the first student may receive questions from the question recommendation server 100 and may be recommended content related to the second student by the question recommendation server 100. A detailed process in which the terminal 200 of the first student is recommended content will be described in detail with reference to FIGS. 2 through 9. In addition, an answer to a given question or a process of solving the question may be input to the terminals 200 and 300 of the students, and additional information about question solving may be input. However, information that is input is not limited to this example. The terminal 300 of the second student may be composed of one terminal or a plurality of terminals 300_1 through 300_n, and the number of terminals is not limited.

The terminals 200 and 300 of the students may be computing devices capable of performing wired/wireless communication such as personal computers (PCs) and notebook computers or may be electronic devices such as cellular terminals, kiosks, smartphones equipped with displays and personal digital assistants (PDAs). However, the terminals 200 and 300 are not limited to these devices and may be various types of devices which can receive content from the question recommendation server 100 and output the received content and into which information can be input.

In an embodiment, the terminal 300 of the second student may play the role of the terminal 200 of the first student, and the terminal 200 of the first student may play the role of the terminal 300 of the second student. That is, the terminal 200 or 300 of each student can become the terminal 200 of the first student or the terminal 300 of the second student.

The network 400 may be implemented as any type of wired/wireless network such as a local area network (LAN), a wide area network (WAN), a mobile radio communication network, or wireless broadband Internet (Wibro).

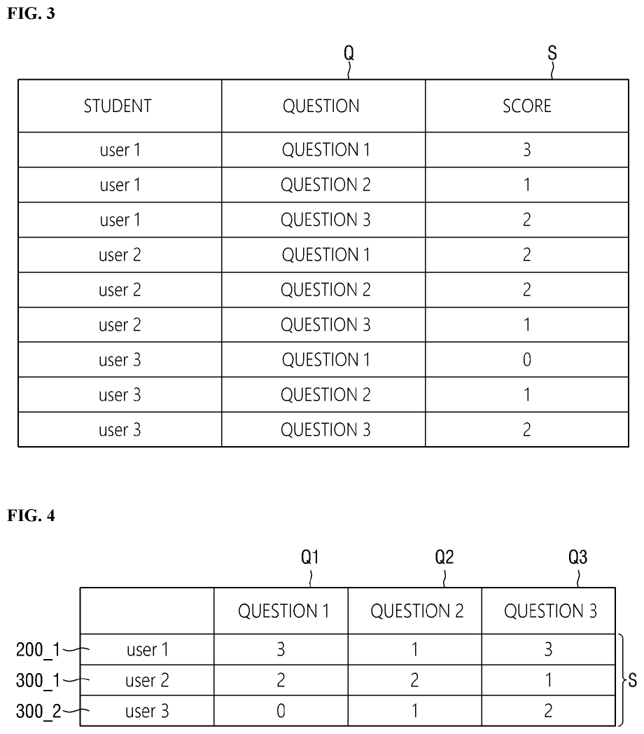

FIG. 2 is a flowchart illustrating a similarity-based question recommendation method S100 according to an embodiment. FIG. 3 is a score data table stored in a similarity-based question recommendation server according to an embodiment.

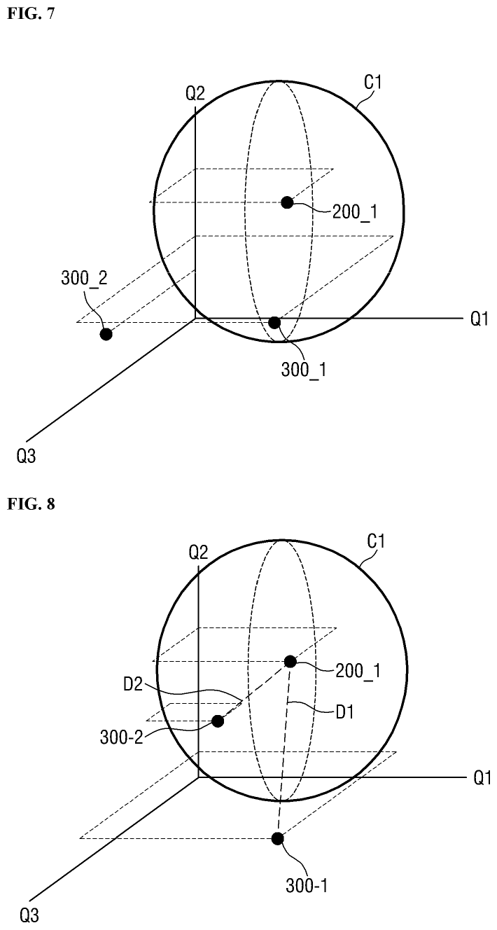

Referring to FIG. 2, the similarity-based question recommendation method S100 according to the embodiment may include forming a point indicating a first student and a point indicating a second student in a first Euclidean space (operation S110), comparing a student reference distance C (see FIG. 7) with a student absolute distance D (see FIG. 6) in the first Euclidean space (operation S120), determining whether the student absolute distance D is equal to or less than the student reference distance C (operation S130), and recommending content related to the second student to a terminal 200 of the first student (operation S140).

The similarity-based question recommendation method S100 according to the embodiment is performed by the question recommendation server 100 as described above. First, the point indicating the first student and the point indicating the second student may be formed in the first Euclidean space using score data of the first student and score data of the second student.

Referring to FIG. 3, score data includes each student's score S for each question Q. In the score data of FIG. 3, student IDs for identifying terminals 200 and 300 of students may be classified as user 1 through user 3, question numbers for identifying questions Q may be classified as question 1 Q1 through question 3 Q3, and scores S for each question may be stored. The score data of FIG. 3 shows that user 1 has earned 3, 1 and 2 points, user 2 has earned 2, 2 and 1 points, and user 3 has earned 0, 1, and 2 points on questions 1 through 3 Q1 through Q3, respectively. The score data of FIG. 3 is merely an example, and the number of students and the number of questions can be increased or decreased. Different scores S may be stored depending on the answers that the terminals 200 and 300 of the students input for each question, and the form of the score data table may be variously changed accordingly.

Each question Q may be set as an easy, intermediate, or difficult question, and the maximum score that can be earned may vary depending on the level of difficulty. In addition, in the score data, different scores S may be awarded even for the same question Q depending on input values. That is, in the score data, even for the same question, different scores S may be awarded according to a preset criterion depending on the answers chosen. For example, in the case of an objective question, different points may be assigned to each answer, and different scores may be awarded depending on the answers chosen by the students' terminals 200 and 300. In the case of a subjective question, different scores may be awarded depending on the degree of similarity in the number of letters and the form by matching letters of a correct answer with letters of an input answer.

FIG. 4 is a table obtained by rearranging the score data of FIG. 3, and FIG. 4B illustrates a first Euclidean space formed using the table.

Referring to FIG. 4, the table of FIG. 4 includes the same values as the score data of FIG. 3, but is a score table obtained by rearranging the score data for each question based on each student.

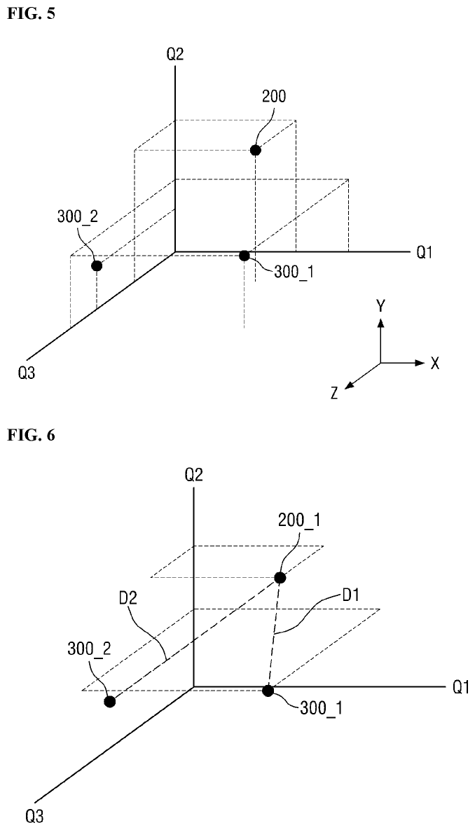

Referring to FIG. 5, the question recommendation server 100 may form a virtual first Euclidean space and form points in the first Euclidean space by using the score table of FIG. 4. The first Euclidean space may be composed of a plurality of axes corresponding to one or more questions, respectively. Specifically, the question recommendation server 100 may set questions as an x axis, a y axis, and a z axis of the first Euclidean space, respectively. In FIG. 5, the question recommendation server 100 may set the x axis as question 1 Q1 such that scores for question 1 Q1 increase along the x axis, may set they axis as question 2 Q2 such that scores for question 2 Q2 increase along they axis, and may set the z axis as question 3 Q3 such that scores for question 3 Q3 increase along the z axis. Since there are three questions in FIG. 5, the first Euclidean space is expressed in three dimensions. However, if there are four or more questions, the first Euclidean space may have four or more dimensions. In this case, the first Euclidean space cannot be visually expressed, but the question recommendation server 100 may form points of students using a virtual logical first Euclidean space. FIG. 5 is merely an example used to express FIG. 4, and the first Euclidean space is not limited to this example. If there are hundreds or thousands of data, the first Euclidean space may be a virtual space of hundreds or thousands of dimensions.

The question recommendation server 100 may set a student who will be recommended content among a plurality of students stored in FIG. 4 as a first student and may set the other students as second students. The question recommendation server 100 may set user 1 200 stored in FIG. 4 as a first student which will be recommended content and set user 2 300_1 and user 3 300_2 as second students. Accordingly, the question recommendation server 100 may form a point indicating the first student and points indicating the second students in the first Euclidean space by using the first student's scores S for Q1, Q2 and Q3 and the second students' scores S for Q1, Q2 and Q3. The question recommendation server 100 may form a point at a position corresponding to 3, 1 and 3 which are scores for Q1, Q2 and Q3 of the first student, may form a point at a position corresponding to 2, 2 and 1 which are scores for Q1, Q2 and Q3 of the second student corresponding to user 2 300_1, and form a point at a position corresponding to 0, 1 and 2 which are scores for Q1, Q2 and Q3 of the second student corresponding to user 3 300_2.

In an embodiment, in a similarity-based question recommendation method S100 according to an embodiment, each axis of the first Euclidean space may correspond to a plurality of questions, and a plurality of questions corresponding to one axis may be selected based on attributes irrelevant to the content of the questions. Specifically, the question recommendation server 100 may form students' points in the first Euclidean space as in FIG. 4B and then cluster questions such that each axis corresponds to a plurality of questions. If the question recommendation server 100 clusters questions such that each axis corresponds to a plurality of questions, the number of axes of the first Euclidean space can be reduced, and information can be simplified.

Generally, questions are clustered based on attributes highly relevant to the content of the questions such as subject, question number, and difficulty level. However, in the similarity-based question recommendation method S100 according to the embodiment, questions may be clustered based on attributes irrelevant to the content of the questions. For example, the question recommendation server 100 may cluster questions based on attributes irrelevant to the content of the questions, such as creation times of the questions, creators of the questions, the size of font in which the questions are written, and the type of font. In this case, the question recommendation server 100 can reconstruct data by changing the first Euclidean space to various forms and offer the unexpectedness of recommending new questions so that a student can look at questions from a new point of view.

FIG. 6 illustrates absolute distances between students' points formed in FIG. 5.

Referring to FIG. 6, the question recommendation server 100 may measure a student absolute distance D from the point of the first student to the point of each second student. The student absolute distance D refers to a distance between students' points. As illustrated in FIG. 6, the question recommendation server 100 may measure student absolute distances D1 and D2 from the point 200 of the first student to the point 300_1 of the second student corresponding to user 2 and to the point 300_2 of the second student corresponding to user 3. The question recommendation server 100 may measure a straight distance from the point 200 of the first student to the point 300 of each second student in order to measure the student absolute distance D. Here, the question recommendation server 100 may measure the student absolute distance D using a Euclidean distance equation. The Euclidean distance equation may calculate a distance between two points by substituting the two points for

$$= \sqrt{{( {q}_{1} - {p}_{1} )}^{3} + {( {q}_{2} - {p}_{2} )}^{2} + … + {( {q}_{n} - {p}_{o} )}^{2}} = \sqrt{{\sum }_{i = 1}^{n} {( {q}_{i} - {p}_{i} )}^{2}}$$

when the two points are represented by (p1, p2, p3, p4, . . . , pn) and (q1, q2, q3, q4, . . . , qn).

The question recommendation server 100 may substitute (3, 1, 3) which is the point of the first student and (2, 2, 1) which is the point 300_1 of the second student corresponding to user 2 for the Euclidean distance equation in order to measure the student absolute distance D1 from the first student to the point 300_1 of the second student corresponding to user 2. In this case, the question recommendation server 100 may calculate the student absolute distance D1 between the point of the first student and the point 300_1 of the second student corresponding to user 2 to be \sqrt{1²+1²+2²}=\sqrt{6}. In addition, the question recommendation server 100 may substitute (3, 1, 3) which is the point of the first student and (0, 1, 2) which is the point 300_2 of the second student corresponding to user 3 for the Euclidean distance equation in order to measure the student absolute distance D2 from the first student to the point 300_2 of the second student corresponding to user 3. In this case, the question recommendation server 100 may calculate the student absolute distance D2 between the point 200 of the first student and the point 300_2 of the second student corresponding to user 3 to be \sqrt{3²+0²+1²}=\sqrt{10}. Therefore, the question recommendation server 100 may determine that the second student 300_1 corresponding to user 2 is located closer to the first student 200 than the second student 300_2 corresponding to user 3.

If scores earned by students for each question are similar, points of the students are formed at similar positions in the first Euclidean space. Therefore, the question recommendation server 100 may determine that students separated by a small student absolute distance D have similar academic levels. In addition, if scores earned by students for each question are different, points of the students are formed far away from each other in the first Euclidean space. Therefore, the question recommendation server 100 may determine that students separated by a large student absolute distance D have different academic levels.

In the comparing of the student reference distance C which will be described later with the student absolute distance D between the point 200 of the first student and the point 300 of the second student in the first Euclidean space, the question recommendation server 100 may find a second student whose student absolute distance D is the shortest by comparing student absolute distances D of points 300_1, . . . , 300_n of a plurality of second students from the point of the first student. The question recommendation server 100 may measure the student absolute distances D between the first student and the second students and recommend content related to a second student having the shortest absolute distance D to the terminal 200 of the first student. In an embodiment, once the question recommendation server 100 finds a second student having the shortest student absolute distance D, it may recommend content related to the second student to the terminal 200 of the first student without comparing the student absolute distance D with the student reference distance C.

Here, the content related to the second student may be a question provided to the terminal 300 of the second student.

Therefore, in the similarity-based question recommendation method S100 according to the embodiment, it is possible to find a student whose learning ability is most similar to that of a specific student by using scores for questions and thus possible to efficiently induce the specific student to gradually enhance his or her learning ability by providing the specific student with questions provided to the student whose learning ability is most similar to that of the specific student. This disclosure can more efficiently recommend questions to students by applying a collaborative filtering technique, which is one of the algorithm recommendation techniques of an artificial intelligence (AI) system, to a question recommendation algorithm.

When recommending the content related to the second student to the terminal 200 of the first student, the question recommendation server 100 may provide the terminal 200 of the first student with question content to which a review check signal has been input from the terminal 300 of the second student. The review check signal may be a check signal that the second student has manually input to the terminal 300 of the second student in order to view a corresponding question again later. In this case, a question that the second student considers important can be recommended to the terminal 200 of the first student in the similarity-based question recommendation method S100 according to the embodiment. Thus, a question that a similar learner considers important can be recommended to a student.

FIG. 7 illustrates student reference distances from the point of the first student.

The question recommendation server 100 may recommend content related to a second student to the terminal 200 of the first student if a student absolute distance D of the second student is the shortest among a plurality of second students and is equal to or less than a student reference distance C. Referring to FIG. 7, the question recommendation server 100 may create a virtual area based on student reference distances C1 from the point of the first student. The question recommendation server 100 may calculate a student reference distance C1 based on the similarity between learning related data of the first student and learning related data of the second student. Here, the question recommendation server 100 may calculate the student reference distance C1 for each student. For ease of description, the student reference distances C1 are shown in the shape of a sphere in FIG. 7 based on the assumption that all of the student reference distances C1 are the same.

The question recommendation server 100 may calculate the student reference distances C1 before calculating the student absolute distances D measured in FIG. 6, may calculate the student absolute distances D and the student reference distances C1 at the same time, or may calculate the student reference distances C1 after calculating the student absolute distances D. That is, the order of calculating the student reference distances C1 and the student absolute distances D is not limited. The question recommendation server 100 may calculate the student reference distance C1 to be short when the similarity between the learning related data of the first student and the learning related data of the second student is high and may calculate the student reference distance C1 to be long when the similarity is low.

The question recommendation server 100 may calculate the student reference distances C1 using learning related data. The learning related data may be data that stores information needed for a student to learn. The learning related data may include a student's profile data such as age, grade, physical details, residential area, personality, hobby and specialty and may be received from an external server or may be entered by the student or a server administrator. In addition, the learning related data may include a student's learning data such as academic level, grade ranking, graph of change in grade ranking, achieved scores by subject, graph of change in achieved scores by subject, class intelligence quotient, emotional quotient, assignments such as content requiring additional learning for each student, assignments such as optional content for additional learning, the time taken to solve each question, the time taken to input an answer after a question is displayed on a terminal, data about the process of solving each question, data about the order of keywords in an essay answer to a question, and a review check signal for each question. This learning data may be received from an external server or may be automatically generated for each student by the question recommendation server 100.

The question recommendation server 100 may compare a student reference distance C1 calculated using the learning related data with a student absolute distance D of a second student and recommend content provided to the second student located at the student absolute distance D to the terminal 200 of the first student if the student absolute distance D is equal to or less than the student reference distance C1. Since the second student is regarded as similar to the first student when the student absolute distance D is equal to or less than the student reference distance C1, the second student is more likely to be included in the student reference distance C1 as the student reference distance C1 increases and less likely to be included in the student reference distance C1 as the student reference distance C1 decreases. When the student absolute distance D is equal to or less than the student reference distance C1, the question recommendation server 100 may recommend content related to the second student to the terminal 200 of the first student. This recommendation may be made only when the student absolute distance D of the second student is equal to or less than the student reference distance C1 and may not be made when the student absolute distance D exceeds the student reference distance C1 even if the student absolute distance D is the shortest. For example, when the student reference distance C is maximum because the similarity between the learning related data of the first student and the learning related data of the second students is high, if there is any student whose absolute distance is the shorter than the reference distance, the question recommendation server 100 may recommend content related to the second student to the terminal 200 of the first student. However, when the student reference distance C1 converges to zero because the similarity between the learning related data of the first student and the learning related data of the second students is low, the question recommendation server 100 may not recommend content related to the second student whose absolute distance D exceeds zero to the terminal 200 of the first student even if the absolute distance D of the second student is the shortest. Therefore, in the similarity-based question recommendation method S100 according to the embodiment, the student reference distances C1 can be used to filter out irrelevant students.

In an embodiment, the question recommendation server 100 may calculate the student reference distance C1 to be shorter as the similarity between the learning related data of the first student and the learning related data of the second student is higher. That is, in this case, the student reference distance C1 may be calculated to be longer as the similarity between the learning related data of the first student and the second student is lower, and the second student whose absolute distance is the shortest is located within the student reference distance C1. Therefore, the question recommendation server 100 may recommend content from the second student, whose learning related data is not similar to that of the first student, to the first student. In this case, a question recommendation server 100 according to an embodiment may recommend questions from a student, whose environment other than question scores is different from that of a specific student as much as possible, to the specific student, thereby helping the specific student acquire a point of view from which the student of a completely different style looks at questions.

The question recommendation server 100 may calculate the student reference distance C1 based on the similarity of the above-described learning related data by using the profile data or the leaning data in the learning related data. For example, the question recommendation server 100 may calculate the student reference distance C1 based on the profile data in the learning related data. The question recommendation server 100 may determine that the similarity of the learning related data is high when there are students who have the same age, grade, physical details, residential area, personality, hobby, or specialty. Each piece of the learning related data may be quantified into a number or grade according to a predetermined method in order to measure the degree of similarity. The learning related data may also be regarded as numbers or grades having the same numeral.

The question recommendation server 100 may determine the similarity of the learning related data by using the entire profile data or a combination of data included in the profile data. For example, the question recommendation server 100 may determine the similarity between the learning related data based only on students' age or may determine the similarity between the learning related data based on two pieces of data, e.g., students' age and grade. In addition, the question recommendation server 100 may determine the similarity between the learning related data based on students' physical details, residential area, personality, hobby or specialty or may determine the similarity between the learning related data based on students' age, physical details and residential area. That is, the question recommendation server 100 can determine the similarity between the learning related data by variously combining students' profile data.

If the first student and the second student have the same age and grade, the question recommendation server 100 may determine that the similarity between the learning related data of the first student and the second student is high. In this case, since the learning related data of the first student and the second student are completely the same, the question recommendation server 100 may set the student reference distance C to a maximum distance by determining that the similarity between the learning related data is maximum. Therefore, the question recommendation server 100 may determine that the student absolute distance D of the second student is included in the student reference distance C and recommend content related to the second student to the terminal 200 of the first student if the student absolute distance D of the second student is shorter than those of other second students.

The question recommendation server 100 may calculate the student reference distance C1 based on the similarity of the learning related data by using the times taken to input answers after a question is displayed on the terminal of the first student and the terminal 300 of the second student. In this case, since the similarity between a student who solves the question very quickly and a student who solves the question very slowly is low, the student reference distance C1 may be calculated to be short. Also, since the similarity between students who solve the question quickly or between students who solve the question slowly is high, the student reference distance C1 may be calculated to be long.

In addition, the question recommendation server 100 may calculate the student reference distance C1 based on the similarity of the learning related data by using the orders of keywords in essay answers of the terminal of the first student and the terminal of the second student to a question. In this case, since the similarity between a student who accurately solves all of the essay questions and a student who hardly solves the essay questions is low, the student reference distance C1 may be calculated to be short. Also, since the similarity between students who solve questions quickly or slowly is high, the student reference distance C1 may be calculated to be long. For example, when keywords in an essay answer are A, B and C, if keywords used in the first student's essay answer appear in the order of A, B and C and keywords used in the second student's essay answer appear in the order of C, B and A, it can be assumed that there is about 50% similarity because A, B and C exist in both essay answers, but the order is opposite. However, if the keywords used in the second student's essay answer appear in the order of D, C and B, it can be assumed that there is about 30% similarity because B and C exist in both essay answers, but the order is opposite. By determining the degree of similarity according to whether the same keywords exist in essay answers and the orders of the keywords as described above, it is possible to determine how similar students' logical development styles are. Accordingly, the similarity-based question recommendation method S100 can effectively enhance a specific student's learning ability by recommending questions from a student whose logical thinking ability is similar that of the specific student.

The question recommendation server 100 may form an area that connects dots respectively indicating the student reference distances C1 in the first Euclidean space. The question recommendation server 100 can form an area using the student reference distances C1 when points of second students are formed at various positions. That is, the question recommendation server 100 may display a dot at the student reference distance C1 corresponding to a point of each second student and may form an area of the student reference distances C1 in the process of displaying dots at numerous student reference distances C1. In FIG. 7, since the student reference distances C1 from the first student to a plurality of second students are the same, the question recommendation server 100 may form an area of the student reference distances C1 of the second students in the shape of a sphere.

In addition, in an embodiment, when all of the student reference distances C1 from the first student to the second students are maximum, the question recommendation server 100 may determine that all of the student absolute distances D of the second students are included in the student reference distances C1 and may recommend content related to a second student whose student absolute distance D is the shortest among the second students to the terminal 200 of the first student, that is, may recommend content based only on the student absolute distances D regardless of the student reference distances C1 as illustrated in FIG. 6.

FIG. 8 illustrates the students' points of FIG. 4 moved after the update of the score data.

Referring to FIG. 8, the question recommendation server 100 may move the positions of points formed in the first Euclidean space as the score data is updated. The question recommendation server 100 may update the score data of FIG. 3 as the first student 200 and the second students 300 continue to solve questions and may change the positions of the students' points in the first Euclidean space accordingly. Here, it is assumed that only the score data is changed while the student reference distances C1 remain unchanged. Therefore, the student absolute distance D1 of the point 300_1 of the second student corresponding to user 2 which is located within the student reference distance C1 in FIG. 7 exceeds the student reference distance C1 in FIG. 8. On the other hand, the student absolute distance D2 of the point 300_2 of the second student corresponding to user 3 which exceeds the student reference distance C1 in FIG. 7 is located within the student reference distance C1 in FIG. 8.

Accordingly, the similarity-based question recommendation method S100 according to the embodiment can more accurately identify the similarity between students as the score data becomes more abundant over time.

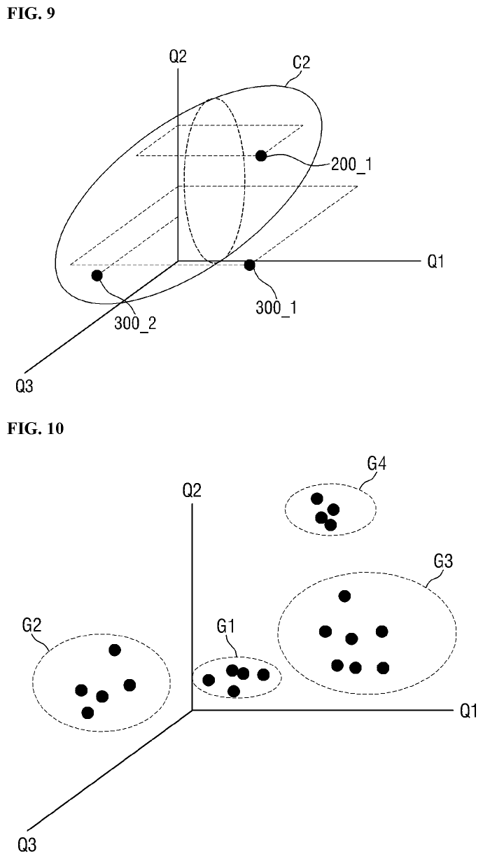

FIG. 9 illustrates the student reference distances of FIG. 7 changed after the update of the learning related data.

Referring to FIG. 9, the question recommendation server 100 may change the form of the virtual area connecting the student reference distances C2 in the first Euclidean space as the student reference distances C2 are changed due to the update of the learning related data. In FIG. 9, the student absolute distance D1 of the second student corresponding to user 2 is shorter than those of other second students but exceeds the student reference distance C2. In this case, the question recommendation server 100 may recommend content related to the second student 300_2 corresponding to user 3 to the terminal 200 of the first student because the student absolute distance D2 of the second student 300_2 corresponding to use 3 is equal to or less than the student reference distance C2 although the student absolute distance D2 of the second student 300_2 corresponding to user 3 is longer than the student absolute distance D1 of the second student 300_1 corresponding to user 2.

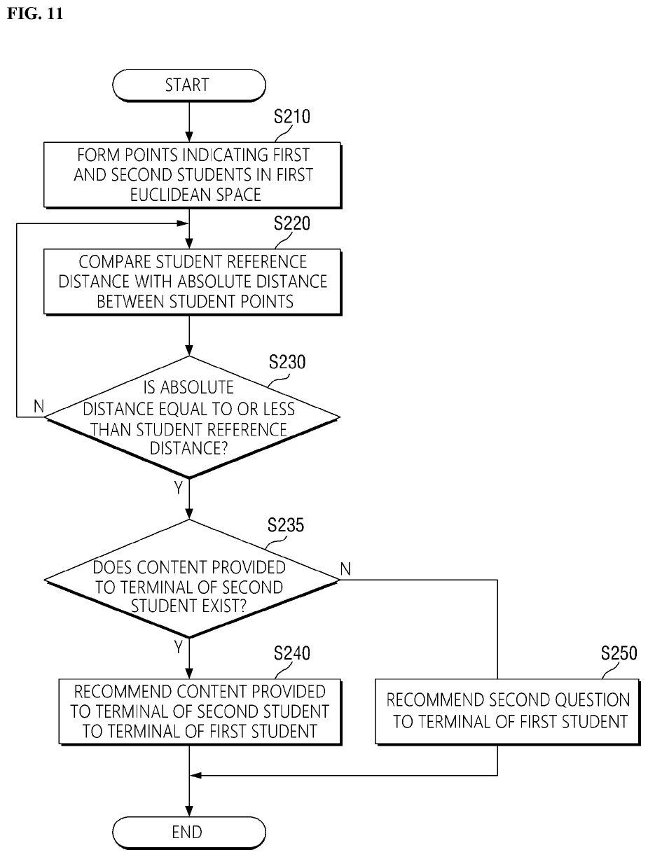

FIG. 10 illustrates each level group of students concentrated within a predetermined range.

Referring to FIG. 10, in the similarity-based question recommendation method S100, when points formed in the first Euclidean space are concentrated within an area of a predetermined range, students corresponding to the concentrated points may be formed as a level group, and a group absolute distance between level groups G1 through G4 may be measured to recommend content between nearest groups. A value for an area of a predetermined range may be input to the question recommendation server 100 in advance and may be changed by a user.

FIG. 10 is a flowchart illustrating a similarity-based question recommendation method S200 according to an embodiment.

Referring to FIG. 10, the similarity-based question recommendation method S200 according to the embodiment may include forming points indicating students in a first Euclidean space (operation S210), comparing a student reference distance C with an absolute distance between the points of the students (operation S220), and determining whether the absolute distance is equal to or less than the student reference distance C (operation S230). These operations are the same as those of the similarity-based question recommendation method S100 according to the previous embodiment, and thus a description thereof is omitted. Next, the question recommendation server 100 may determine whether content provided to a terminal 300 of a second student exists (operation S235). Here, if the content provided to the terminal 300 of the second student exists, the question recommendation server 100 may recommend the content provided to the terminal 300 of the second student to a terminal 200 of a first student as in the previous embodiment (operation S240). However, if the content provided to the terminal 300 of the second student does not exist, the question recommendation server 100 may recommend a second question to the terminal 200 of the first student (operation S250).

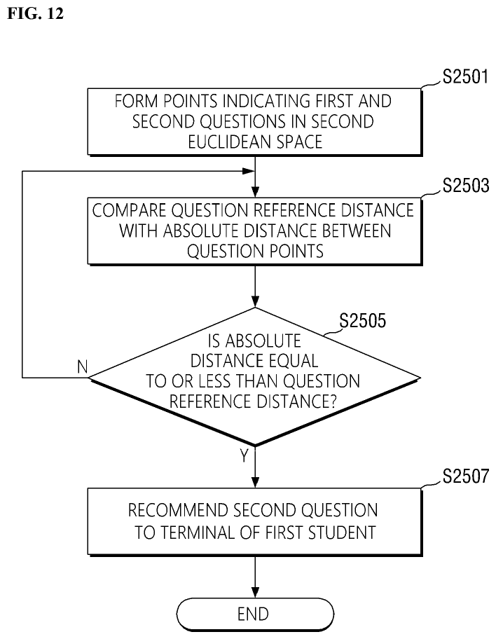

FIG. 12 is a flowchart illustrating operation S250 of FIG. 10 in detail.

Referring to FIG. 12, to find a similar question, the question recommendation server 100 may form a point indicating a first question and a point indicating a second question in a second Euclidean space by using score data of the first student and score data of the second student (operation S2501). Then, the question recommendation server 100 may compare a question reference distance with a question absolute distance between the points of the questions (operation S2503), determine whether the question absolute distance is equal to or less than the question reference distance (operation S2505), and recommend the second question to the terminal 200 of the first student if the question absolute distance is equal to or less than the question reference distance (operation S2507). Here, the second question may be a question not provided to the terminal 200 of the first student, and the first question may be a question provided to the terminal 200 of the first student.

Accordingly, the similarity-based question recommendation method S200 according to the embodiment can recommend content similar to content provided to the first student even when there is no second student similar to the first student or when content to be recommended to the first student is insufficient because there is no content provided to the second student.

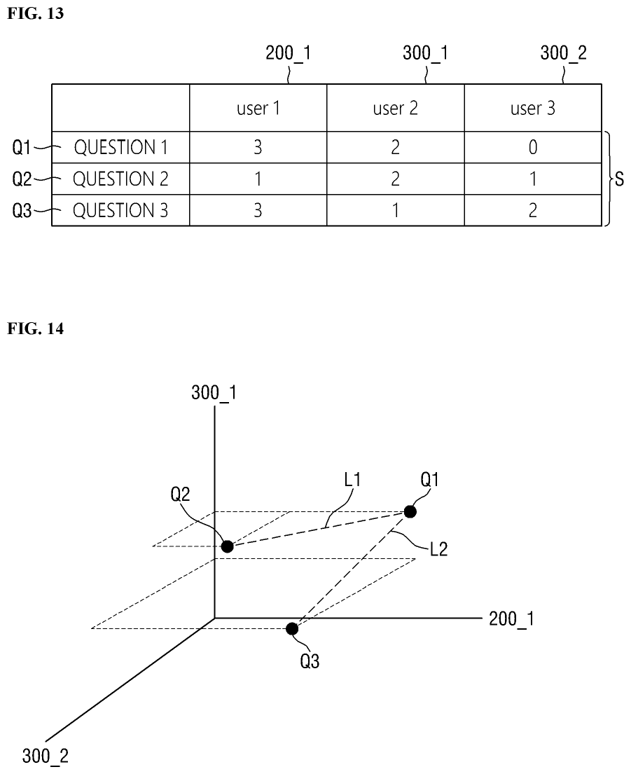

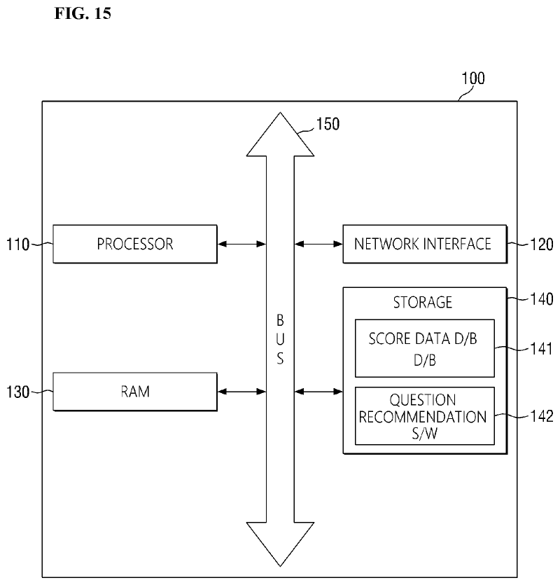

FIG. 13 is a table obtained by rearranging the score table of FIG. 3, and FIG. 14 illustrates a second Euclidean space formed using the table.

Referring to FIG. 13, the table of FIG. 13 includes the same values as the score data of FIG. 3 but is a score table obtained by rearranging the score data for each question based on each student.

Referring to FIG. 14, the question recommendation server 100 may form a virtual second Euclidean space and form points in the second Euclidean space by using the score table of FIG. 13. The second Euclidean space may be composed of a plurality of axes indicating students, respectively. Specifically, the question recommendation server 100 may set students as an x axis, a y axis, and a z axis of the second Euclidean space, respectively. In FIG. 14, the question recommendation server 100 may set the x axis as user 1 200_1 such that scores of user 1 200_1 for a question increase along the x axis, may set the y axis as user 2 300_1 such that scores of user 2 300_1 for a question increase along the y axis, and may set the z axis as user 3 300_2 such that scores of user 3 300_2 for a question increase along the z axis. Since there are three students in FIG. 14, the second Euclidean space is expressed in three dimensions. However, if there are four or more students, the second Euclidean space may have four or more dimensions. In this case, the second Euclidean space cannot be visually expressed, but the question recommendation server 100 may form points of students using a virtual logical second Euclidean space. FIG. 14 is merely an example used to express FIG. 13, and the second Euclidean space is not limited to this example. If there are hundreds or thousands of data, the second Euclidean space may be a virtual space of hundreds or thousands of dimensions. The question recommendation server 100 may set a first question as Q1 and second questions as Q2 and Q3 as illustrated in FIG. 12.

In the case of FIG. 14, a question absolute distance may be calculated using the Euclidean distance equation described above. A question absolute distance L1 between question 1 Q1 and question 2 Q2 is \sqrt{2²+0²+1²}=\sqrt{5}, and a question absolute distance L2 between question 1 Q1 and question 3 Q3 is \sqrt{0²+1²+2²}=\sqrt{5}. A question reference distance may be a distance input in advance. Since the question absolute distances L1 and L2 from question 1 Q1 to questions 2 and 3 Q2 and Q3 are the same, the question recommendation server 100 may determine that the two questions Q2 and Q3 are equally similar to question 1 Q1. Therefore, the question recommendation server 100 may recommend both of the two questions to the first student.

In an embodiment, the question recommendation server 100 may recommend the second questions Q2 and Q3 to the terminal 200 of the first student only when an answer input to the terminal 200 of the first student for the first question Q1 is incorrect. Therefore, the question recommendation server 100 can induce the first student to repeatedly learn the questions that he or she answered incorrectly.

In an embodiment, the question recommendation server 100 may recommend the second questions Q2 and Q3 to the first student only when the levels of difficulty of the second questions Q2 and Q3 are higher than that of the first question Q1. Therefore, the question recommendation server 100 can induce the first student to deepen learning.

In the similarity-based question recommendation method S200 according to the embodiment, the question reference distance may be calculated based on the similarity between question related data of the first question Q1 and question related data of each of the second questions Q2 and Q3. Here, the question related data may be data about the order of keywords in an essay answer to a question or the time taken to input an answer after each of the first question Q1 and the second questions Q2 and Q3 is displayed on a terminal. The data about the order of keywords in an essay answer may be a numerical value given according to the order of keywords that must be included in an essay answer and the similarity of the orders of the keywords. Therefore, the question recommendation server 100 may analyze the correlation of numeral values by comparing the numerical values. In addition, the question recommendation server 100 may analyze the correlation between question solving times, that is, analyze whether a student who takes a long time to solve the first question also takes a long time to solve the second questions based on the times taken to input answers after the first question Q1 and the second questions Q2 and Q3 are displayed on a terminal. The question recommendation server 100 may also analyze the correlation between incorrect answer rates, that is, analyze whether a student who answers the first question correctly or incorrectly also answers the second questions correctly or incorrectly. The question recommendation server 100 may determine the degree of similarity based on this correlation and may calculate the question reference distance to be long if the degree of similarity is high and calculate the question reference distance to be short if the degree of similarity is low.

In the similarity-based question recommendation method S200 according to the embodiment, when the first Euclidean space is formed, coordinate axes may be clustered based on the question reference distance. In this case, the question recommendation server 100 can effectively bundle similar questions together by clustering the coordinate axes of the first Euclidean space using the question reference distance calculated in the second Euclidean space, thereby simplifying data and reproducing the score data as more useful data.

FIG. 15 illustrates the hardware configuration of a question recommendation server 100 according to an embodiment.

Referring to FIG. 15, the question recommendation server 100 according to the embodiment may include one or more processors 110, a network interface 120, a memory 130 which loads a computer program to be executed by the processors 110, and a storage 140 which stores one or more software 141 and 142.

The processors 110 control the overall operation of each component of the question recommendation server 100. The processors 110 may include a central processing unit (CPU), a micro-processor unit (MPU), a micro-controller unit (MCU), or any form of processor well known in the art to which the present disclosure pertains. In addition, the processors 110 may perform an operation on at least one application or program for executing methods according to embodiments. The question recommendation server 100 may include one or more processors 110.

The network interface 120 supports wired and wireless Internet communication of the question recommendation server 100. In addition, the network interface 120 may support various communication methods other than Internet communication. To this end, the network interface 120 may include a communication module well known in the art to which the present disclosure pertains.

The network interface 120 may receive score data from the terminals 200 and 300 of the students through the network 400 and provide content to the terminal 200 of the first student based on the result of analyzing the terminal 300 of the second student.

The memory 130 stores various data, commands and/or information.

The memory 130 may load one or more programs 141 and 142 from the storage 140 in order to execute a similarity-based question recommendation method S100 according to embodiments. In FIG. 15, a random access memory (RAM) is illustrated as an example of the memory 130. However, the memory 130 is not limited to the RAM and may be any component that can load one or more programs 141 and 142.

The storage 140 may non-temporarily store a question database, a score database, student related data, and question related data. In FIG. 15, question recommendation software 142 is illustrated as an example of the programs.

The storage 140 may include a non-volatile memory such as a read only memory (ROM), an erasable programmable ROM (EPROM), an electrically erasable programmable ROM (EEPROM) or a flash memory, a hard disk, a removable disk, or any form of computer-readable recording medium well known in the art to which the present disclosure pertains.

The question recommendation software 142 may perform an instruction for forming a point indicating a first student and a point indicating a second student in a first Euclidean space by using score data of the first student and score data of the second student, wherein the first Euclidean space is composed of a plurality of axes corresponding to one or more questions, respectively, an instruction for comparing a student reference distance calculated based on the similarity between learning related data of the first student and learning related data of the second student with a student absolute distance between the point of the first student and the point of the second student in the first Euclidean space, and an instruction for recommending content related to the second student to a terminal 200 of the first student if the student absolute distance is equal to or less than the student reference distance.

The methods according to the embodiments described above can be performed by the execution of a computer program implemented as computer-readable code. The computer program may be transmitted from a first computing device to a second computing device through a network such as the Internet and may be installed in the second computing device and thus used in the second computing device. Examples of the first computing device and the second computing device include fixed computing devices such as servers, physical servers belonging to server pools for cloud services, and desktop PCs.

The computer program may be stored in a recording medium such as a DVD-ROM or a flash memory.

The concepts of the invention described can be embodied as computer-readable code on a computer-readable medium. The computer-readable medium may be, for example, a removable recording medium (a CD, a DVD, a Blu-ray disc, a USB storage device, or a removable hard disc) or a fixed recording medium (a ROM, a RAM, or a computer-embedded hard disc). The computer program recorded on the computer-readable recording medium may be transmitted to another computing apparatus via a network such as the Internet and installed in the computing apparatus. Hence, the computer program can be used in the computing apparatus.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

While the present invention has been particularly illustrated and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A similarity-based question recommendation method performed by a computing device, the method comprising:
forming a point indicating a first student and a point indicating a second student in a first Euclidean space by using score data of the first student and score data of the second student;
comparing a student reference distance calculated based on the similarity between learning related data of the first student and learning related data of the second student with a student absolute distance between the point of the first student and the point of the second student in the first Euclidean space; and
recommending content related to the second student to a terminal of the first student if the student absolute distance is equal to or less than the student reference distance,
wherein the first Euclidean space is comprised of a plurality of axes corresponding to one or more questions, respectively.

2. The method of claim 1, wherein the content related to the second student is a question provided to a terminal of the second student.

3. The method of claim 2, wherein the recommending of the content related to the second student to the terminal of the first student comprises:
providing question content to which a review check signal has been input from the terminal of the second student to the terminal of the first student.

4. The method of claim 1, wherein the recommending of the content related to the second student to the terminal of the first student comprises:
providing content presented to the terminal of the second student as content requiring additional learning to the terminal of the first student.

5. The method of claim 1, wherein the recommending of the content related to the second student to the terminal of the first student comprises:
providing question solving process data input to the terminal of the second student to the terminal of the first student.

6. The method of claim 1, wherein each axis of the first Euclidean space corresponds to a plurality of questions, and a plurality questions corresponding to one axis are selected based on attributes irrelevant to content of the questions.

7. The method of claim 1, wherein the learning related data is the time taken to input an answer after a question is displayed on a terminal.

8. The method of claim 1, wherein the learning related data is data about the order of keywords in an essay answer to a question.

9. The method of claim 1, wherein the student reference distance is calculated to be longer as the similarity between the learning related data of the first student and the learning related data of the second student is higher.

10. The method of claim 1, wherein the student reference distance is calculated to be shorter as the similarity between the learning related data of the first student and the learning related data of the second student is higher.

11. The method of claim 1, wherein the recommending of the content related to the second student to the terminal of the first student comprises:
forming students corresponding to points formed in the first Euclidean space as a level group if the points are concentrated within an area of a predetermined range and measuring a group absolute distance between level groups to recommend content between nearest groups.

12. The method of claim 1, wherein the recommending of the content related to the second student to the terminal of the first student comprises:
forming a point indicating a first question and a point indicating a second question in a second Euclidean space by using the score data of the first student and the score data of the second student if the content related to the second student does not exist; and
recommending the second question to the terminal of the first student if a question absolute distance between the point of the first question and the point of the second question in the second Euclidean space is equal to or less than a question reference distance,
wherein the second Euclidean space is comprised of a plurality of axes indicating students, respectively, the second question is a question not provided to the terminal of the first student, and the first question is a question provided to the terminal of the first student.

13. The method of claim 12, wherein the recommending of the second question to the terminal of the first student comprises:
recommending the second question to the terminal of the first student only when an answer input to the terminal of the first student for the first question is incorrect.

14. The method of claim 12, wherein the recommending of the second question to the terminal of the first student comprises:
recommending the second question to the first student only when a level of difficulty of the second question is higher than that of the first question.

15. The method of claim 12, wherein the question reference distance is calculated based on the similarity between question related data of the first question and question related data of the second question.

16. The method of claim 15, wherein the question related data is data about the order of keywords in an essay answer to a question.

17. The method of claim 15, wherein the question related data is the time taken to input an answer after each of the first question and the second question is displayed on a terminal.

18. The method of claim 15, wherein coordinate axes of the first Euclidean space are clustered based on the question reference distance.

19. A question recommendation server comprising:
a processor;
a network interface;
a memory; and
a computer program which is loaded into the memory and executed by the processor,
wherein the computer program comprises:
an instruction for forming a point indicating a first student and a point indicating a second student in a first Euclidean space by using score data of the first student and score data of the second student, wherein the first Euclidean space is comprised of a plurality of axes corresponding to one or more questions, respectively;
an instruction for comparing a student reference distance calculated based on the similarity between learning related data of the first student and learning related data of the second student with a student absolute distance between the point of the first student and the point of the second student in the first Euclidean space; and
an instruction for recommending content related to the second student to a terminal of the first student if the student absolute distance is equal to or less than the student reference distance.

20. A computer program coupled to a computing device and stored in a computer-readable recording medium to execute:
an operation of forming a point indicating a first student and a point indicating a second student in a first Euclidean space by using score data of the first student and score data of the second student, wherein the first Euclidean space is comprised of a plurality of axes corresponding to one or more questions, respectively;
an operation of comparing a student reference distance calculated based on the similarity between learning related data of the first student and learning related data of the second student with a student absolute distance between the point of the first student and the point of the second student in the first Euclidean space; and
an operation of recommending content related to the second student to a terminal of the first student if the student absolute distance is equal to or less than the student reference distance.
